(19) United States
(12) Patent Application Publication
(10) Pub. No.: US 2021/0104884 A1
(43) Pub. Date: Apr. 8, 2021

(54) CIRCUIT PROTECTION DEVICE

(71) Applicant: SMART ELECTRONICS INC., Ulsan (KR)

(72) Inventors: Doo Won KANG, Gyeonggi-do (KR); A Lam SHIN, Busan (KR)

(73) Assignee: SMART ELECTRONICS INC.

(21) Appl. No.: 17/035,875

(22) Filed: Sep. 29, 2020

(30) Foreign Application Priority Data
Oct. 7, 2019 (KR) 10-2019-0123686

(51) Int. Cl. H02H 5/04; H01C 7/04; H01H 85/165

(52) U.S. Cl. CPC H02H 5/042; G01K 7/22; H01H 85/165; H01C 7/04

(57) ABSTRACT

Disclosed is a circuit protection device including a case, a negative temperature coefficient thermistor accommodated in the case and including a resistant heating element, a pair of electrodes installed on both sides of the resistant heating element, and a first thermistor lead wire and a second thermistor lead wire withdrawn from the pair of electrodes, respectively, and a fuse accommodated in the case and including a fuse body and a first fuse lead wire and a second fuse lead wire connected to both ends of the fuse body, respectively. Here, the fuse body includes a fuse rod with a plating layer formed thereon and a pair of fuse caps coupled to both ends of the fuse rod and having conductivity, and the first fuse lead wire and the second fuse lead wire are bonded to the pair of fuse caps, respectively.

### CROSS-REFERENCE TO RELATED APPLICATION

This application claims priority to and the benefit of Korean Patent Application No. 2019-0123686, filed on Oct. 7, 2019, the disclosure of which is incorporated herein by reference in its entirety.

### FIELD

The present invention relates to a circuit protection device, and more particularly, to a circuit protection device configured to restrict an inrush current when an electronic product is initially driven and to prevent fire caused by an increase in internal temperature or an overcurrent.

### BACKGROUND

In general, in an electric circuit of a large electronic product such as an air conditioner, a washer, a refrigerator, a dryer, or the like, a circuit protection device is provided at a power input terminal of the electric circuit and protects a power circuit to prevent a failure caused by an inrush current, an increase in internal temperature, a continuous overcurrent, and the like which occur when power is turned on.

FIG. 1 illustrates components and operations of an existing circuit protection device. The existing circuit protection device includes a fuse resistor RF, a first relay S1 connected to the fuse resistor RF in a series, and a second relay S2 connected to the fuse resistor RF and the first relay S1 in parallel. The fuse resistor RF includes a resistor R and a thermal fuse F, and the resistor R and the thermal fuse F are connected to each other in series.

The circuit protection device is converted from state (a), in which the first relay S1 is closed and the second relay S2 is opened at a driving time, into state (b) in which the first relay S1 is opened and the second relay S2 is closed after a certain time.

In state (a), an input current is input to an electrical circuit via the fuse resistor RF and the first relay S1. Here, when the resistor R limits an inrush current to a certain current and an overcurrent flows thereinto, heat generated by the resistor R is conducted to the thermal fuse F and a fused body including solid lead or polymer pellets provided inside the thermal fuse F is fused to short-circuit a circuit so as to protect an electrical circuit of a home appliance. After a certain time (for example, about 0.5 seconds) in which the inrush current disappears and the input current is stabilized, the circuit protection device is changed to state (b) so that a normal input current passes through the second relay S2 and is input to the electrical circuit.

Since the circuit protection device includes three components including the fuse resistor RF and the first relay S1 and the second relay S2 which have a relatively great volume, costs are high and a larger space is occupied. Also, a normal input current is within a range from 2 A to 4 A in the case of a washer and is 7 A or higher in the case of a dryer. Accordingly, it is necessary to use high-current relays for the first relay S1 and the second relay S2. Here, since the high-current relays are high-priced and there are less commercialized domestic goods, most high-current relays have to be imported from Japan and the like.

In addition, since operations of the first relay S1 and the second relay S2 being opened or closed are repetitively performed whenever an electronic product is turned on or off, as the electronic product is used for a long time, durability thereof decreases and a malfunction occurs. The malfunctions of the first relay S1 and the second relay S2 may cause an inflow of an overcurrent or even cause fire. Accordingly, such risks are inherent all the time in the circuit protection device using relays.

### SUMMARY

The present invention is directed to providing a circuit protection device capable of replacing a circuit protection device, which includes a fuse resistor RF, a first relay S1, and a second relay S2, as well as reducing costs and less occupying a space without using relays.

Aspects of the present invention are not limited to the above-stated aspects and other unstated aspects of the present invention will be understood by those skilled in the art from a following description.

According to an aspect of the present invention, there is provided a circuit protection device including a case, a negative temperature coefficient thermistor accommodated in the case and including a resistant heating element, a pair of electrodes installed on both sides of the resistant heating element, and a first thermistor lead wire and a second thermistor lead wire withdrawn from the pair of electrodes, respectively, and a fuse accommodated in the case and including a fuse body and a first fuse lead wire and a second fuse lead wire connected to both ends of the fuse body, respectively. Here, the fuse body includes a fuse rod with a plating layer formed thereon and a pair of fuse caps coupled to both ends of the fuse rod and having conductivity, and the first fuse lead wire and the second fuse lead wire are bonded to the pair of fuse caps, respectively. Also, the second thermistor lead wire and the first fuse lead wire are connected to each other in the case.

The circuit protection device may further include a first pin connected to the first thermistor lead wire and a second pin connected to the second fuse lead wire. Here, a first guide groove configured to guide the first pin to be withdrawn outward from the case and a second guide groove configured to guide the second pin to be withdrawn outward from the case may be formed in the case.

The first pin and the second pin may include plate-shaped bodies having one sides connected to the first thermistor lead wire and the second fuse lead wire, respectively, and each include at least one extending portion extending from the other side of the body with a width smaller than that of the body.

The bodies of the first pin and the second pin may include first parts having one sides connected to the first thermistor lead wire and the second fuse lead wire and inserted into the first guide groove and the second guide groove, respectively, and include second parts extending from other sides of the first parts with a width greater than that of the first parts and withdrawn outward from the case.

The case may include a partition wall extending from an inner wall of the case and disposed between the resistant heating element and the fuse body.

According to another aspect of the present invention, there is provided a circuit protection device including a case, a first negative temperature coefficient thermistor accommodated in the case and including a first resistant heating element, a pair of electrodes installed on both sides of the first resistant heating element, and a first thermistor lead wire and a second thermistor lead wire withdrawn from the pair of electrodes, respectively, a second negative temperature coefficient thermistor accommodated in the case and including a second resistant heating element, a pair of electrodes installed on both sides of the second resistant heating element, and a third thermistor lead wire and a fourth thermistor lead wire withdrawn from the pair of electrodes, respectively, and a fuse accommodated in the case and including a fuse body and a first fuse lead wire and a second fuse lead wire connected to both ends of the fuse body, respectively. Here, the fuse body includes a fuse rod with a plating layer formed thereon and a pair of fuse caps coupled to both ends of the fuse rod and having conductivity, and the first fuse lead wire and the second fuse lead wire are bonded to the pair of fuse caps, respectively. The first thermistor lead wire and the third thermistor lead wire are connected to each other in the case. Also, the second thermistor lead wire, the fourth thermistor lead wire, and the first fuse lead wire are connected to one another in the case.

The circuit protection device may further include a first pin connected to the first thermistor lead wire and the third thermistor lead wire and a second pin connected to the second fuse lead wire. Here, a first guide groove configured to guide the first pin to be withdrawn outward from the case and a second guide groove configured to guide the second pin to be withdrawn outward from the case may be formed in the case.

The first pin may include a plate-shaped body having one side connected to the first thermistor lead wire and the third thermistor lead wire and may include at least one extending portion extending from the other side of the body with a width smaller than that of the body. The body may include a first part having one side connected to the first thermistor lead wire and the third thermistor lead wire and inserted into the first guide groove and may include a second part extending from the other side of the first part with a width greater than that of the first part to be located outside the case.

The second pin may include a plate-shaped body having one side connected to the second fuse lead wire and may include at least one extending portion extending from the other side of the body with a width smaller than that of the body. The body of the second pin may include a first part having one side connected to the second fuse lead wire and inserted into the second guide groove and may include a second part extending from the other side of the first part with a width greater than that of the first part to be located outside the case.

The case may include a partition wall extending from an inner wall of the case and disposed among the first resistant heating element, the second resistant heating element, and the fuse body.

The first resistant heating element and the second resistant heating element may be disposed to face each other.

The circuit protection device may further include a first cable having one end connected to the first thermistor lead wire and the third thermistor lead wire and a second cable having one end connected to the second fuse lead wire. Here, a first guide groove configured to guide the first cable to be withdrawn outward from the case and a second guide groove configured to guide the second cable to be withdrawn outward from the case may be formed in the case.

According to still another embodiment of the present invention, there is provided a circuit protection device including a case, a first negative temperature coefficient thermistor accommodated in the case and including a first resistant heating element, a pair of electrodes installed on both sides of the first resistant heating element, and a first thermistor lead wire and a second thermistor lead wire withdrawn from the pair of electrodes, respectively, a fuse accommodated in the case and including a fuse body and a first fuse lead wire and a second fuse lead wire connected to both ends of the fuse body, respectively, and a second negative temperature coefficient thermistor accommodated in the case and including a second resistant heating element, a pair of electrodes installed on both sides of the second resistant heating element, and a third thermistor lead wire and a fourth thermistor lead wire withdrawn from the pair of electrodes, respectively. Here, the fuse body includes a fuse rod with a plating layer formed thereon and a pair of fuse caps coupled to both ends of the fuse rod and having conductivity, and the first fuse lead wire and the second fuse lead wire are bonded to the pair of fuse caps, respectively. Also, the second thermistor lead wire and the first fuse lead wire are connected to each other and the second fuse lead wire and the third thermistor lead wire are connected to each other in the case.

The circuit protection device may further include a first pin connected to the first thermistor lead wire and a second pin connected to the fourth thermistor lead wire. Here, a first guide groove configured to guide the first pin to be withdrawn outward from the case and a second guide groove configured to guide the second pin to be withdrawn outward from the case may be formed in the case.

The first pin and the second pin may include plate-shaped bodies having one sides connected to the first thermistor lead wire and the fourth thermistor lead wire, respectively, and each include at least one extending portion extending from the other side of the body with a width smaller than that of the body.

The bodies of the first pin and the second pin may include first parts having one sides connected to the first thermistor lead wire and the fourth thermistor lead wire and inserted into the first guide groove and the second guide groove, respectively, and may include second parts extending from other sides of the first parts with a width greater than that of the first parts and withdrawn outward from the case.

The case may include a partition wall extending from an inner wall of the case and disposed among the first resistant heating element, the second resistant heating element, and the fuse body.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1A & 1B illustrate components and operations of an existing circuit protection device;

FIG. 2 is a perspective view of a circuit protection device according to a first embodiment of the present invention;

FIGS. 3A and 3B are cross-sectional views illustrating a negative temperature coefficient thermistor 20 which is shown in FIG. 2 and taken along lines A-A and B-B, respectively;

FIG. 4 is a detailed configuration diagram illustrating a fuse 30 shown in FIG. 2;

FIG. 5 is a perspective view illustrating a state in which a case 10 accommodates the negative temperature coefficient thermistor 20, the fuse 30, and the like which are shown in FIG. 2 and then is filled with a filler;

FIG. 6 is a perspective view of a circuit protection device according to a second embodiment of the present invention;

FIGS. 7A and 7B are cross-sectional views illustrating negative temperature coefficient thermistors 50 and 60 which are shown in FIG. 6 and taken along lines A-A and B-B, respectively;

FIG. 8 is a perspective view illustrating a state in which the case 10 accommodates the negative temperature coefficient thermistors 50 and 60, the fuse 30, and the like which are shown in FIG. 6 and then is filled with a filler;

FIG. 9 illustrates a state in which the circuit protection device according to the first or second embodiment of the present invention is mounted on a circuit board;

FIG. 10 is a perspective view of a circuit protection device according to a third embodiment of the present invention;

FIGS. 11A and 11B are cross-sectional views illustrating the first negative temperature coefficient thermistor 20 shown in FIG. 10 and taken along lines A-A and B-B, respectively;

FIGS. 12C and 12D are cross-sectional views illustrating a second negative temperature coefficient thermistor 40 shown in FIG. 10 and taken along lines C-C and D-D, respectively;

FIG. 13 is a perspective view illustrating a state in which the case 10 accommodates the negative temperature coefficient thermistors 20 and 40, the fuse 30, and the like which are shown in FIG. 10 and then is filled with a filler;

FIG. 14 is a perspective view of a circuit protection device according to a fourth embodiment of the present invention; and

FIG. 15 is a perspective view illustrating a state in which the case 10 accommodates the negative temperature coefficient thermistors 50 and 60, the fuse 30, and the like which are shown in FIG. 14 and then is filled with a filler.

### DETAILED DESCRIPTION

Hereinafter, exemplary embodiments of the present invention will be described in detail with reference to the drawings. Hereinafter, throughout the description and the attached drawings, substantially like elements will be referred to as like reference numerals and a repetitive description thereof will be omitted. Also, in a description of the embodiments of the present invention, a detailed description of well-known functions or components of the related art will be omitted when it is deemed to obscure understanding of the embodiments of the present invention.

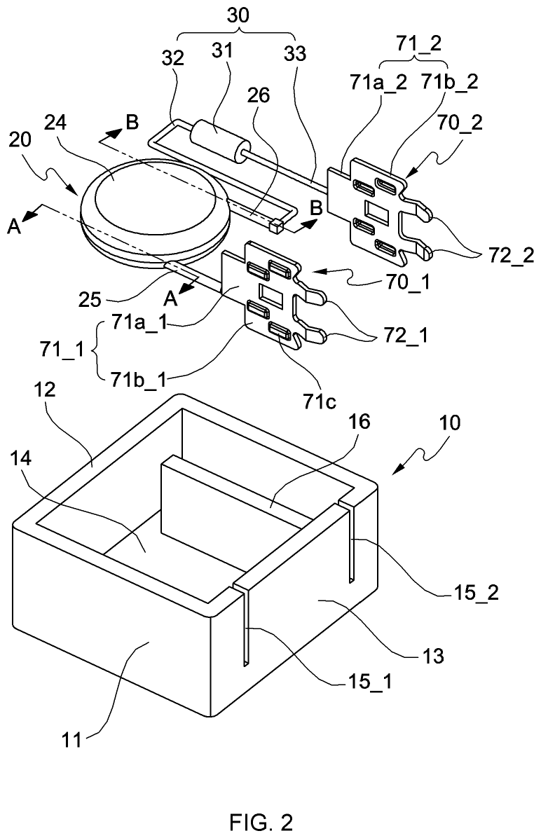

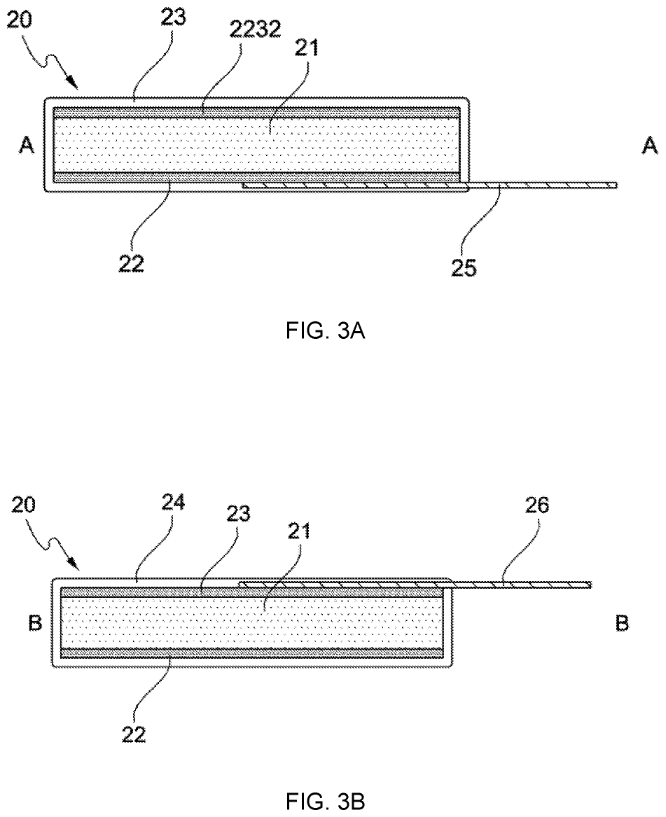

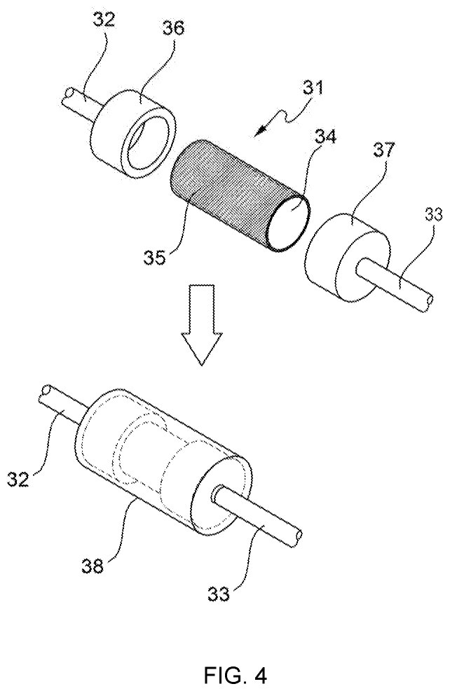

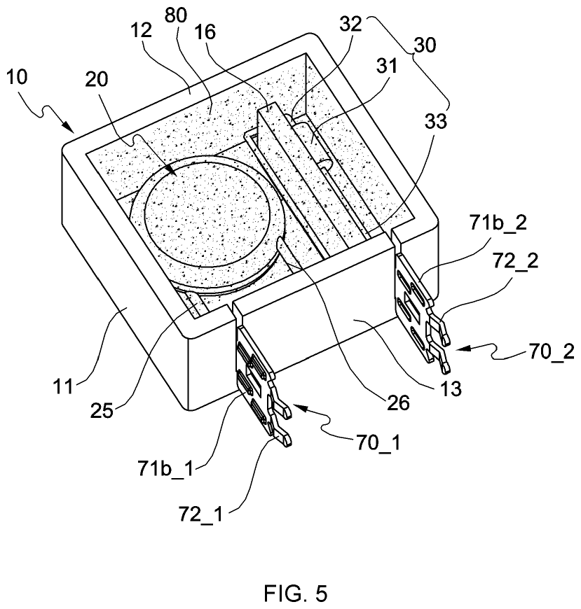

FIGS. 2 to 5 are views illustrating components of a circuit protection device according to a first embodiment of the present invention. FIG. 2 is a perspective view of the circuit protection device according to the first embodiment. FIG. 3 is cross-sectional views illustrating a negative temperature coefficient thermistor 20 which is shown in FIG. 2 and taken along lines A-A and B-B, respectively. FIG. 4 is a detailed configuration diagram illustrating a fuse 30 shown in FIG. 2. FIG. 5 is a perspective view illustrating a state in which a case 10 accommodates the negative temperature coefficient thermistor 20, the fuse 30, and the like which are shown in FIG. 2 and then is filled with a filler.

The circuit protection device according to the first embodiment of the present invention includes the case 10, the negative temperature coefficient thermistor 20, the fuse 30, a first pin 70_1, and a second pin 70_2.

The case 10 is formed of, for example, a ceramic material and includes both sidewalls 11, a front wall 12, a rear wall 13, and a bottom wall 14 so as to form an accommodation groove with an open top in which the negative temperature coefficient thermistor 20 and the fuse 30 are accommodated. A first guide groove 15_1 and a second guide groove 15_2 are formed in the rear wall 13 to guide the first pin 70_1 and the second pin 70_2 to be withdrawn outward from the case 10, respectively.

As shown in FIGS. 2 and 3, the negative temperature coefficient thermistor 20 includes a resistant heating element 21, a pair of electrodes 22 and 23 installed on both sides of the resistant heating element 21, and a first thermistor lead wire 25 and a second thermistor lead wire 26 withdrawn from the pair of electrodes 22 and 23, respectively, which are coated with a coating material 24.

A thermistor is a resistor element having a sensitively varying thermal resistance value, and particularly, has a feature in which an electrical resistance value varies according to a change of a temperature thereof or an ambient temperature. Among such thermistors, a thermistor having a negative temperature coefficient is referred to as a negative temperature coefficient thermistor. The negative temperature coefficient thermistor has a resistance value which decreases according to an increase in a temperature thereof or an ambient temperature.

The fuse 30 includes a fuse body 31 and a first fuse lead wire 32 and a second fuse lead wire 33 which are connected to both ends of the fuse body 31, respectively.

Referring to FIG. 4, the fuse body 31 may include a fuse rod 34, a plating layer 35, a first fuse cap 36, a second fuse cap 37, and a fuse protection layer 35.

The fuse rod 34 may have a cylindrical shape, an angular pillar, or the like and may be formed of a ceramic material.

The plating layer 35 is a conductive coating formed on a surface of the fuse rod 34 and may be formed by forming a tin layer, as a fusible element layer, on a plating layer including a nickel alloy or a copper alloy.

The first fuse cap 36 and the second fuse cap 37 may be inserted into and coupled to both ends of the fuse rod 34 on which the plating layer 35 is formed. To this end, each of the first fuse cap 36 and the second fuse cap 37 may be a cap shape having a container structure (for example, a cylindrical structure or an angular-container structure) with one closed end.

The first fuse lead wire 32 and the second fuse lead wire 33 may be connected to outsides of the first fuse cap 36 and the second fuse cap 37, respectively. The first fuse lead wire 32 and the second fuse lead wire 33 may be bonded to outsides of the first fuse cap 36 and the second fuse cap 37, respectively, through spot welding, laser welding, soldering, or the like.

The fuse protection layer 38 surrounds the fuse rod 34 with the plating layer 35 formed thereon, the first fuse cap 36, and the second fuse cap 37. Accordingly, the fuse protection layer 38 protects the coating of the plating layer 35 and surfaces of the first fuse cap 36 and the second fuse cap 37. Also, the fuse protection layer 38 has an insulation function for insulation from an outside (for example, another component and the like).

As shown in FIG. 2, the second thermistor lead wire 26 of the negative temperature coefficient thermistor 20 and the first fuse lead wire 32 of the fuse body 31 are connected to each other. The second thermistor lead wire 26 and the first fuse lead wire 32 may be connected through soldering, arc welding, spot welding, laser soldering, clamping, or the like.

Meanwhile, the first pin 70_1 and the second pin 70_2 which have conductive materials to be connected to a circuit board so as to perform electrical connection between a circuit and the circuit protection device. The first pin 70_1 includes one end connected to the first thermistor lead wire 25 of the negative temperature coefficient thermistor 20 in the case 10 and extends through the first guide groove 15_1 such that the other end thereof is withdrawn outward from the case 10. The second pin 70_2 includes one end connected to the second fuse lead wire 33 of the fuse 30 in the case 10 and extends through the second guide groove 15_2 such that the other end thereof is withdrawn outward from the case 10.

In the embodiments of the present invention, the first pin 70_1 and the second pin 70_2 perform a function of performing electrical connection between the circuit and the circuit protection device, a function of emitting heat generated by the circuit protection device, and a function of spacing the case 10 at a certain interval apart from the circuit board when the circuit protection device is mounted on the circuit board.

The first pin 70_1 and the second pin 70_2 may include plate-shaped bodies 71_1 and 71_2 and extending portions 72_1 and 72_2 which extend from the bodies 71_1 and 71_2 with widths smaller than those of the bodies 71_1 and 71_2, respectively. Generally, the extending portions 72_1 and 72_2 are parts which are inserted into and soldered to holes of the circuit board to perform electrical connection, and the bodies 71_1 and 71_2 are parts configured to emit heat and space the case 10 at a certain interval apart from the circuit board.

In detail, the first pin 70_1 may include the body 71_1 having one side connected to the first thermistor lead wire 25 and the extending portion 72_1 extending from the other side of the body 71_1 with a width smaller than that of the body 71_1. The second pin 70_2 may include the body 71_2 having one side connected to the second fuse lead wire 33 and the extending portion 72_2 extending from the other side of the body 71_2 with a width smaller than that of the body 71_2. The first thermistor lead wire 25, the second fuse lead wire 33, and the bodies 71_1 and 71_2 may be connected through soldering, arc welding, spot welding, laser soldering, clamping, or the like.

Also, the bodies 71_1 and 71_2 may include first parts 71a_1 and 71a_2 which have a relatively small width and second parts 71b_1 and 71b_2 which have a relatively great width. Generally, the first parts 71a_1 and 71a_2 are parts connected to the lead wires 25 and 33 and inserted into the guide grooves 15_1 and 15_2, and the second parts 71b_1 and 71b_2 are parts which are withdrawn outward from the case 10 so as to space the case 10 at a certain interval apart from the circuit board. Also, the second parts 71b_1 and 71b_2 may each include one or more protruding portions 71c which improve heat dissipation performance.

In detail, the body 71_1 of the first pin 70_1 includes the first part 71a_1 having one side connected to the first thermistor lead wire 25 and inserted into the first guide groove 15_1 and the second part 71b_1 extending from the other side of the first part 71a_1 with a width greater than that of the first part 71a_1 and withdrawn outward from the case 10. The body 71_2 of the second pin 70_2 includes the first part 71a_2 having one side connected to the second fuse lead wire 33 and inserted into the second guide groove 15_2 and the second part 71b_2 extending from the other side of the first part 71a_2 with a width greater than that of the first part 71a_2 and withdrawn outward from the case 10.

Meanwhile, since the negative temperature coefficient thermistor 20 and the fuse 30 are disposed to be adjacent to each other in a sealed space in the case 10 such that a temperature of the circuit protection device or an ambient temperature thereof increases, there is concern that the fuse 30 is short-circuited by heat generation of the negative temperature coefficient thermistor 20 even when it is necessary to prevent the fuse 30 from being short-circuited. Accordingly, a partition wall 16 may be installed between the fuse body 31 and the resistant heating element 21 of the negative temperature coefficient thermistor 20 so as to maintain a certain interval or more between the fuse body 31 and the resistant heating element 21. The partition wall 16 may extend from an inner wall of the case 10, for example, the bottom wall 14 or the rear wall 13. The partition wall 16 is installed not to completely separate both spaces from each other so as to form a path through which the second thermistor lead wire 26 and the first fuse lead wire 32 extend.

Referring to FIG. 5, the case 10 is filled with the filler 80 while accommodating the negative temperature coefficient thermistor 20, the fuse 30, and the like therein. The filler 80 not only supports the negative temperature coefficient thermistor 20 and the fuse 30 in the accommodation grooves but also enables heat dissipation to be effectively performed from the negative temperature coefficient thermistor 20 and the fuse 30. Accordingly, the filler 80 may include a material having a high heat dissipation property.

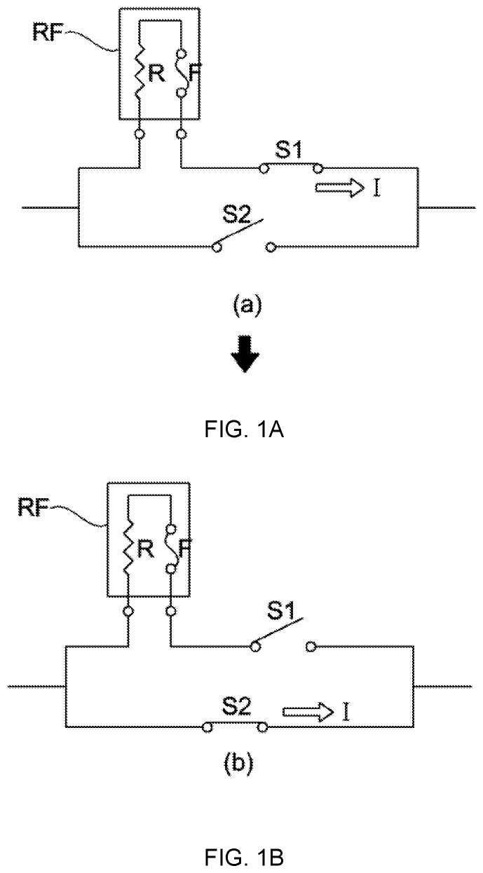

According to the first embodiment of the present invention, since the negative temperature coefficient thermistor 20 has a resistance value which is great at room temperature or a relatively low temperature and decreases according to an increase in a temperature thereof or an ambient temperature, an inrush current is limited to a certain current using a great resistance value at driving time and a normal input current is maintained using a resistance value decreased due to an increase in temperature after a certain time. Simultaneously, when an overcurrent flows into the circuit or the circuit is overheated due to an abnormal phenomenon in the circuit, the fuse 30 is short-circuited and cuts off an inflow of currents so as to prevent fire. Accordingly, the circuit protection device according to the first embodiment may replace an existing circuit protection device shown in FIG. 1. Also, since the negative temperature coefficient thermistor 20 has a relatively small volume and is low-priced in comparison to a high-current relay, a cost of the circuit protection device is reduced and an occupied space is reduced. Also, since relays are not used, it is possible to remove a risk element caused by malfunctions of the relays fundamentally.

Meanwhile, in the case of large home appliances such as an air conditioner, a washer, a refrigerator, a dryer, and the like, since it is necessary to accommodate high currents, a circuit protection device having a high heat generation property is required. In the case of the first embodiment, to reduce heat generation of the negative temperature coefficient thermistor 20, it is necessary to increase a size thereof. Here, as a size of the negative temperature coefficient thermistor 20 increases, manufacturing costs thereof geometrically increases. Accordingly, there is a limitation in reducing a heat generation amount by simply increasing the size of the negative temperature coefficient thermistor 20.

Accordingly, hereinafter, as embodiments capable of reducing a heat generation amount of a circuit protection device without increasing a size of a negative temperature coefficient thermistor as well as having all advantages of the first embodiment, embodiments, in which a heat generation amount is reduced by connecting two negative temperature coefficient thermistors in parallel and reducing a resistance value using a synthetic resistance value thereof, are provided. For convenience, in the following embodiments, a redundant description overlapped with the first embodiment will be omitted.

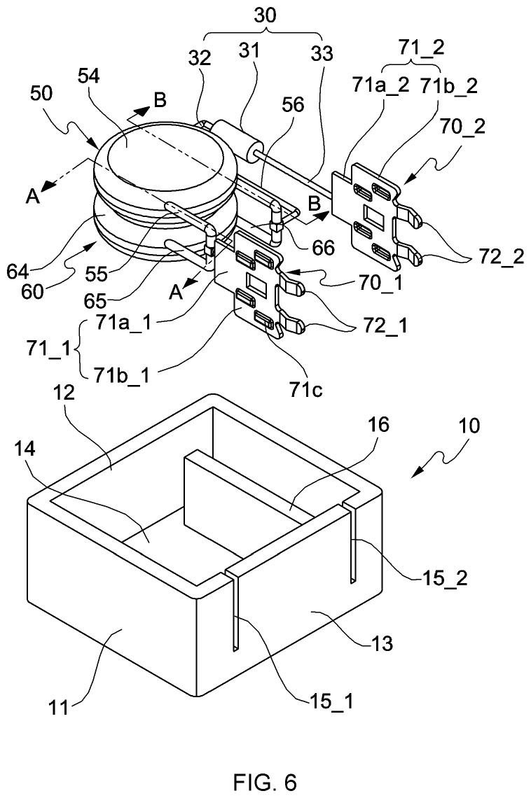

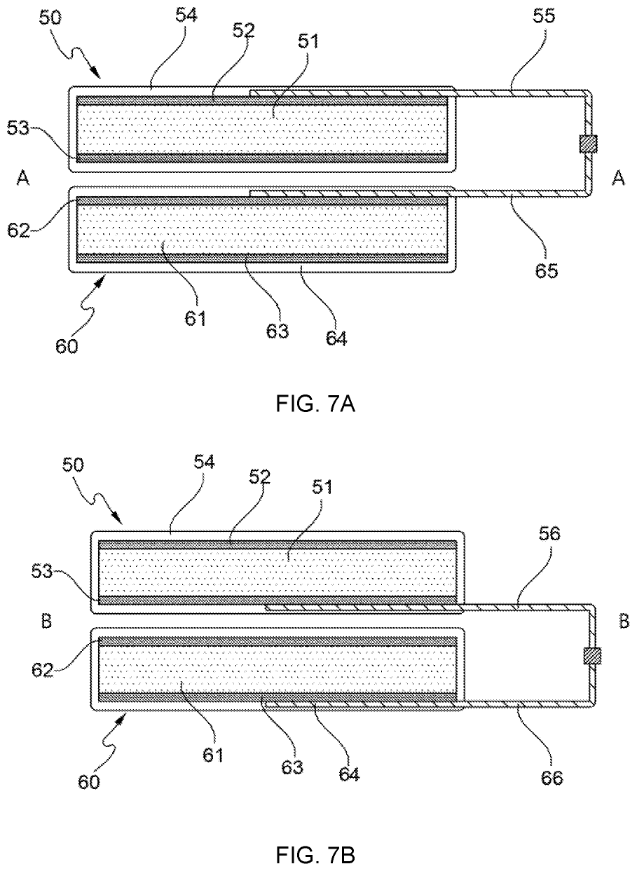

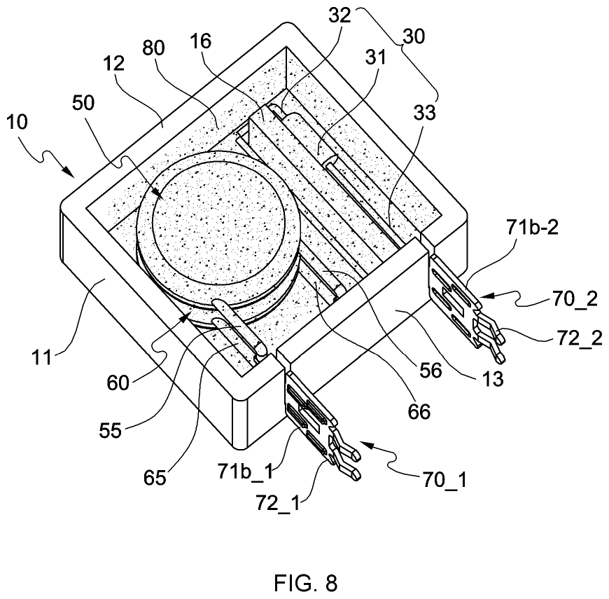

FIGS. 6 to 8 are views illustrating components of a circuit protection device according to a second embodiment of the present invention. FIG. 6 is a perspective view of the circuit protection device according to the second embodiment. FIG. 7 is cross-sectional views illustrating negative temperature coefficient thermistors 50 and 60 which are shown in FIG. 6 and taken along lines A-A and B-B, respectively. FIG. 8 is a perspective view illustrating a state in which the case 10 accommodates the negative temperature coefficient thermistors 50 and 60, the fuse 30, and the like which are shown in FIG. 6 and then is filled with a filler.

The circuit protection device according to the second embodiment of the present invention includes the case 10, a first negative temperature coefficient thermistor 50, a second negative temperature coefficient thermistor 60, the fuse 30, the first pin 70_1, and the second pin 70_2.

The case 10 includes the both sidewalls 11, the front wall 12, the rear wall 13, and the bottom wall 14 so as to form an accommodation groove with an open top in which the first negative temperature coefficient thermistor 50, the second negative temperature coefficient thermistor 60, and the fuse 30 are accommodated. The first guide groove 15_1 and the second guide groove 15_2 are formed in the rear wall 13 to guide the first pin 70_1 and the second pin 70_2 to be withdrawn outward from the case 10, respectively.

As shown in FIGS. 6 and 7, the first negative temperature coefficient thermistor 50 includes a first resistant heating element 51, a pair of electrodes 52 and 53 installed on both sides of the first resistant heating element 51, and a first thermistor lead wire 55 and a second thermistor lead wire 56 withdrawn from the pair of electrodes 52 and 53, respectively, which are coated with a coating material 54. Like the first negative temperature coefficient thermistor 50, the second negative temperature coefficient thermistor 60 includes a second resistant heating element 61, a pair of electrodes 62 and 63 installed on both sides of the second resistant heating element 61, and a third thermistor lead wire 65 and a fourth thermistor lead wire 66 withdrawn from the pair of electrodes 62 and 63, respectively, which are coated with a coating material 64.

The fuse 30 includes the fuse body 31 and the first fuse lead wire 32 and the second fuse lead wire 33 which are connected to both ends of the fuse body 31, respectively.

Referring to FIGS. 6 and 7, the first thermistor lead wire 55 of the first negative temperature coefficient thermistor 50 and the third thermistor lead wire 65 of the second negative temperature coefficient thermistor 60 are connected to each other, and the second thermistor lead wire 56 of the first negative temperature coefficient thermistor 50, the fourth thermistor lead wire 66 of the second negative temperature coefficient thermistor 60, and the first fuse lead wire 32 of the fuse 30 are connected to one another. The lead wires may be connected through soldering, arc welding, spot welding, laser soldering, clamping, or the like.

One end of the first pin 70_1 is connected to the first thermistor lead wire 55 of the first negative temperature coefficient thermistor 50 and the third thermistor lead wire 65 of the second negative temperature coefficient thermistor 60 in the case 10. One end of the second pin 70_2 is connected to the second fuse lead wire 33 of the fuse 30 in the case 10.

The first pin 70_1 may include the body 71_1 having one side connected to the first thermistor lead wire 55 and the third thermistor lead wire 65 and the extending portion 72_1 extending from the other side of the body 71_1 with a width smaller than that of the body 71_1. The second pin 70_2 may include the body 71_2 having one side connected to the second fuse lead wire 33 and the extending portion 72_2 extending from the other side of the body 71_2 with a width smaller than that of the body 71_2. The lead wires may be connected to the bodies through soldering, arc welding, spot welding, laser soldering, clamping, or the like.

The body 71_1 of the first pin 70_1 includes the first part 71a_1 having one side connected to the first thermistor lead wire 55 and the third thermistor lead wire 65 and inserted into the first guide groove 15_1 and the second part 71b_1 extending from the other side of the first part 71a_1 with a width greater than that of the first part 71a_1 and withdrawn outward from the case 10. The body 71_2 of the second pin 70_2 includes the first part 71a_2 having one side connected to the second fuse lead wire 33 and inserted into the second guide groove 15_2 and the second part 71b_2 extending from the other side of the first part 71a_2 with a width greater than that of the first part 71a_2 and withdrawn outward from the case 10.

Meanwhile, the partition wall 16 may be installed between the fuse body 31 and the first and second resistant heating elements 51 and 61 of the first and second negative temperature coefficient thermistors 50 and 60 to maintain a certain interval between the fuse body 31 and the first and second resistant heating elements 51 and 61.

Referring to FIG. 8, the case 10 is filled with the filler 80 while accommodating the first and second negative temperature coefficient thermistors 50 and 60, the fuse 30, and the like therein. The filler 80 not only supports the first and second negative temperature coefficient thermistors 50 and 60 and the fuse 30 in the accommodation grooves but also enables heat dissipation to be effectively performed from the first and second negative temperature coefficient thermistors 50 and 60 and the fuse 30.

Meanwhile, in the embodiment, the first resistant heating element 51 and the second resistant heating element 61 have a plate shape overall and are disposed to be adjacent to and face each other. Since the first resistant heating element 51 and the second resistant heating element 61 are disposed to be adjacent to and face each other, the size of the circuit protection device may be reduced while simultaneously the first resistant heating element 51 and the second resistant heating element 61 thermally influence each other so as to reduce a thermal imbalance. That is, when currents flow through both the resistant heating elements 51 and 61, the resistant heating elements 51 and 61 generate heat. Here, heat may be transferred from a resistant heating element having a great heat generation amount to a resistant heating element having a small heat generation amount so as to relieve the thermal imbalance between the resistant heating elements 51 and 61.

Also, the first resistant heating element 51 and the second resistant heating element 61 may have same resistance values or have different resistance values. Since the first resistant heating element 51 and the second resistant heating element 61 have a parallel connection structure even having any resistance values, a synthetic resistance value becomes smaller than a resistance value of the first resistant heating element 51 and a resistance value of the second resistant heating element 61. Accordingly, it is possible to implement a circuit protection device having a relatively small synthetic resistance value, which is difficult to be implemented using only one of the first resistant heating element 51 or the second resistant heating element 61.

Particularly, when the first resistant heating element 51 and the second resistant heating element 61 have different resistance values, heat from one of the first resistant heating element 51 and the second resistant heating element 61, which has a smaller resistance value, is transferred to another thereof, which has a greater resistance value, so as to promote variations in resistance of the resistant heating element having the greater resistance value. For example, when inrush currents are applied to a resistant heating element having a resistance value of 5Ω and a resistant heating element having a resistance value of 5.1Ω, the resistant heating element having the resistance value of 5Ω is reduced in resistance to 0.2Ω so that a temperature increases to 130° C. However, the resistant heating element having the resistance value of 5.1Ω is slightly reduced in resistance to 4Ω so that a temperature increases to 45° C. Accordingly, even when a difference between the resistance values of the two resistant heating elements is small, a thermal imbalance is caused between both the thermistors temporarily. However, the thermal imbalance is reduced or relieved with time. Here, since the heat generated from the resistant heating element having the resistance value of 5Ω is transferred to the resistant heating element having the resistance value of 5.1Ω so as to much reduce the resistance value of the resistant heating element having the resistance value of 5.1Ω, a current amount increases even in the resistant heating element having the resistance value of 5.1Ω so that a larger amount of heat is generated even in the resistant heating element having the resistance value of 5.1Ω so as to relieve the thermal imbalance between both the resistant heating elements and actually maintain a certain temperature in a thermal balanced state.

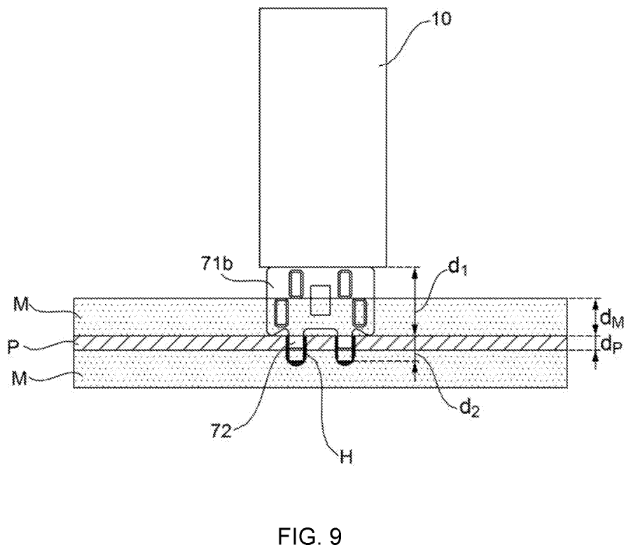

FIG. 9 illustrates a state in which the circuit protection device according to the first or second embodiment of the present invention is mounted on a circuit board P.

Referring to FIG. 9, extending portions 72 of pins 70 of the circuit protection device are inserted into to pass through holes H formed in the circuit board P and soldered thereto so that the circuit protection device is fixed to the circuit board P and electrically connected to an electrical circuit on the circuit board P. Accordingly, a length d2 of the extending portions 72 is formed to be greater than a thickness dP of the circuit board P.

Meanwhile, in the case of an electronic product such as a washer or a dryer to which water is supplied or from which water is generated, the circuit board P includes a molding portion M having a waterproof material such as urethane and the like to protect the circuit board P from water. Since the molding portion M is relatively vulnerable to heat, when heat generated from the circuit protection device is transferred to the molding portion M directly, the molding portion M may be melted and waterproof performance thereof may be degraded. Accordingly, it is necessary to install the case 10 of the circuit protection device to be spaced at a certain interval apart from the circuit board P or the molding portion M. A second part 71b of the pin 70 which is withdrawn outward from the case 10 is installed so that the case 10 is spaced at a certain interval apart from the circuit board P or the molding portion M. The case 10 is spaced as much as a height d1 of the second part 71b apart from the circuit board P. When a thickness of the molding portion M is referred to as dM, the case 10 is spaced as much as d1-dM apart from the molding portion M. Accordingly, d1 may be greater than dM. Also, the molding portion M diffuses heat from the circuit protection device so as to assist heat dissipation.

After resistant heating elements having a diameter of 15ϕ and a resistance value of 8Ω (a synthetic resistance of 4Ω) are used for the first resistant heating element 51 and the second resistant heating element 61 in the second embodiment and a current of 4.4 A is applied to the circuit protection device for a certain time (fifteen minutes), a result of measuring a heat generation temperature of the resistant heating elements, a heat generation temperature of a bottom end of the case 10, and a heat generation temperature of a soldered part of the circuit board P is shown in Table 1.

TABLE 1

| | Resistant | Bottom | | |
|---|---|---|---|---|
| | heating | end of | Soldered | |
| | element | case | part | Remarks |
| Heat | 106.0 | 88.3 | 73.6 | Without |
| generation | | | | urethane |
| temperature | | | | molding |
| (° C.) | | | | |
| Heat | 110.4 | 85.6 | 67.8 | With |
| generation | | | | urethane |
| temperature | | | | molding |
| (° C.) | | | | |

As shown in Table 1, the temperature of the bottom end of the case, which influenced the molding M or the circuit board P directly, adequately decreased rather than the temperature of the resistant heating elements and even the temperature of the soldered part of the circuit board P was 73.6° C. and 67.8° C. which were allowed values. Particularly, the temperature of the bottom end of the case and the temperature of the soldered part were lower in the case with a urethane molding than in the case without urethane molding due to a heat dissipation function of the urethane molding.

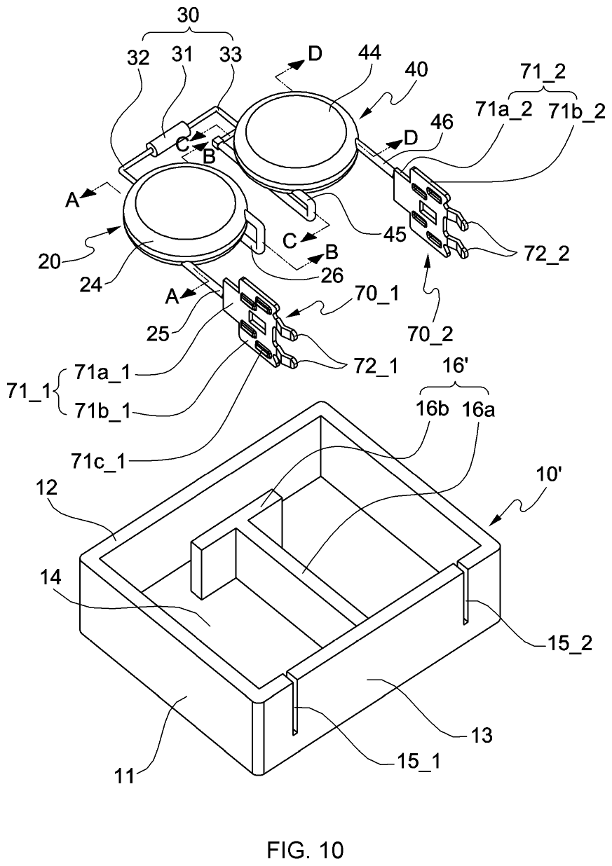

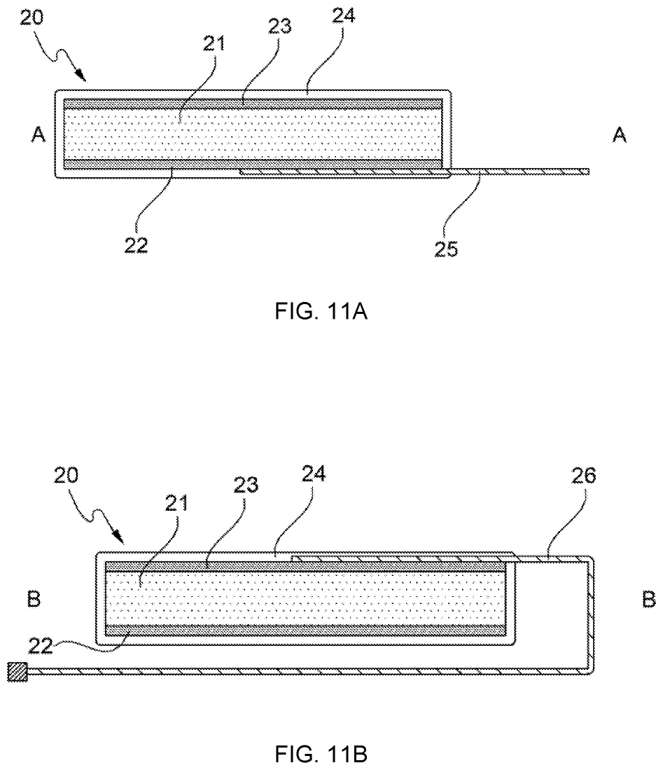

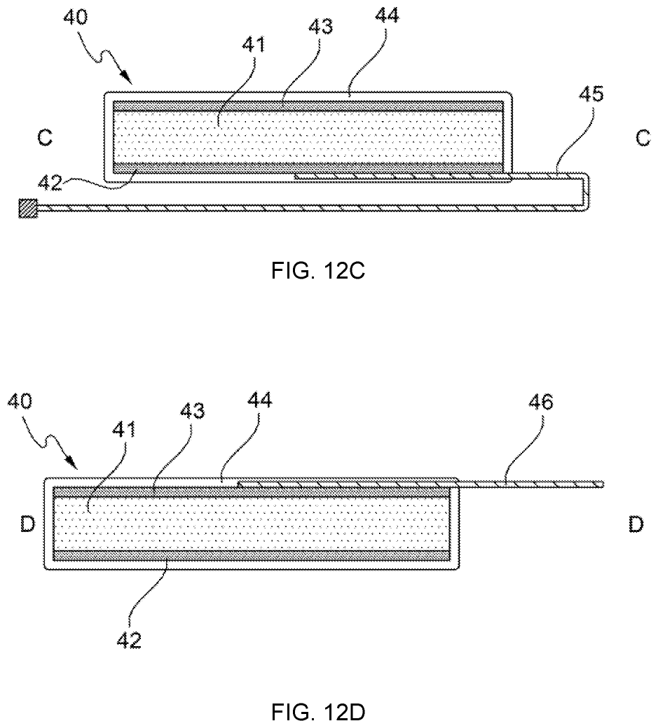

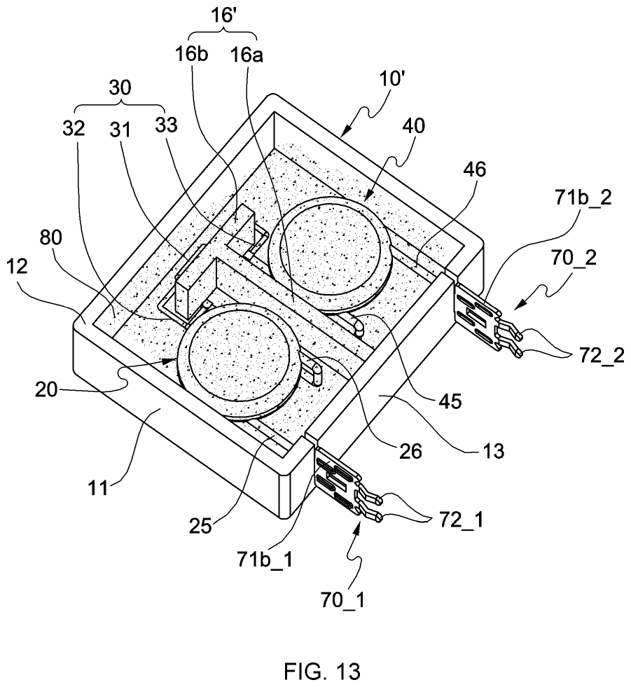

FIGS. 10 to 13 are views illustrating components of a circuit protection device according to a third embodiment of the present invention. FIG. 10 is a perspective view of the circuit protection device according to the third embodiment. FIG. 11 is cross-sectional views illustrating the first negative temperature coefficient thermistor 20 shown in FIG. 10 and taken along lines A-A and B-B, respectively. FIG. 12 is cross-sectional views illustrating a second negative temperature coefficient thermistor 40 shown in FIG. 10 and taken along lines C-C and D-D, respectively. FIG. 13 is a perspective view illustrating a state in which a case 10′ accommodates the negative temperature coefficient thermistors 20 and 40, the fuse 30, and the like which are shown in FIG. 10 and then is filled with a filler.

The circuit protection device according to the third embodiment of the present invention includes the case 10′, the first negative temperature coefficient thermistor 20, the fuse 30, the second negative temperature coefficient thermistor 40, the first pin 70_1, and the second pin 70_2.

The case 10′ includes, for example, a ceramic material and includes the both sidewalls 11, the front wall 12, the rear wall 13, and the bottom wall 14 so as to form an accommodation groove with an open top in which the first negative temperature coefficient thermistor 20, the fuse 30, and the second negative temperature coefficient thermistor 40 are accommodated. The first guide groove 15_1 and the second guide groove 15_2 are formed in the rear wall 13 to guide the first pin 70_1 and the second pin 70_2 to be withdrawn outward from the case 10′, respectively.

As shown in FIGS. 10 and 11, the first negative temperature coefficient thermistor 20 includes the first resistant heating element 21, the pair of electrodes 22 and 23 installed on both sides of the first resistant heating element 21, and the first thermistor lead wire 25 and the second thermistor lead wire 26 withdrawn from the pair of electrodes 22 and 23, respectively, which are coated with the coating material 24.

As shown in FIGS. 10 and 12, the second negative temperature coefficient thermistor 40 includes a second resistant heating element 41, a pair of electrodes 42 and 43 installed on both sides of the second resistant heating element 41, a third thermistor lead wire 45 and a fourth thermistor lead wire 46 withdrawn from the pair of electrodes 42 and 43, respectively, which are coated with a coating material 44.

As shown in FIG. 10, the second thermistor lead wire 26 of the first negative temperature coefficient thermistor 20 and the first fuse lead wire 32 of the fuse 30 are connected to each other. The second thermistor lead wire 26 may be bent and extend to be connectable to the first fuse lead wire 32 of the fuse 30. Also, the second fuse lead wire 33 of the fuse 30 and the third thermistor lead wire 45 of the second negative temperature coefficient thermistor 40 are connected to each other. The third thermistor lead wire 45 may be bent and extend to be connectable to the second fuse lead wire 33. Connection between the second thermistor lead wire 26 and the first fuse lead wire 32 and connection between the second fuse lead wire 33 and the third thermistor lead wire 45 may be performed through soldering, arc welding, spot welding, laser soldering, clamping, or the like.

Meanwhile, the first pin 70_1 and the second pin 70_2 which include conductive materials to be connected to the circuit board so as to perform electrical connection between the circuit and the circuit protection device. The first pin 70_1 has one end connected to the first thermistor lead wire 25 of the first negative temperature coefficient thermistor 20 in the case 10′ and extends through the first guide groove 15_1 such that the other end thereof is withdrawn outward from the case 10′. The second pin 70_2 has one end connected to the fourth thermistor lead wire 46 of the second negative temperature coefficient thermistor 40 in the case 10′ and extends through the second guide groove 15_2 such that the other end thereof is withdrawn outward from the case 10′.

In the embodiment of the present invention, the first pin 70_1 and the second pin 70_2 perform a function of performing electrical connection between the circuit and the circuit protection device, a function of emitting heat generated by the circuit protection device, and a function of spacing the case 10′ at a certain interval apart from the circuit board when the circuit protection device is mounted on the circuit board.

The first pin 70_1 and the second pin 70_2 may include plate-shaped bodies 71_1 and 71_2 and extending portions 72_1 and 72_2 which extend from the bodies 71_1 and 71_2 with widths smaller than those of the bodies 71_1 and 71_2, respectively. Generally, the extending portions 72_1 and 72_2 are parts which are inserted into and soldered to holes of the circuit board to perform electrical connection, and the bodies 71_1 and 71_2 are parts configured to emit heat and space the case 10′ at a certain interval apart from the circuit board.

In detail, the first pin 70_1 may include the body 71_1 having one side connected to the first thermistor lead wire 25 and the extending portion 72_1 extending from the other side of the body 71_1 with a width smaller than that of the body 71_1. The second pin 70_2 may include the body 71_2 having one side connected to the fourth thermistor lead wire 46 and the extending portion 72_2 extending from the other side of the body 71_2 with a width smaller than that of the body 71_2. The first thermistor lead wire 25, the fourth thermistor lead wire 46, and the bodies 71_1 and 71_2 may be connected through soldering, arc welding, spot welding, laser soldering, clamping, or the like.

Also, the bodies 71_1 and 71_2 may include first parts 71a_1 and 71a_2 which have a relatively small width and second parts 71b_1 and 71b_2 which have a relatively great width, respectively. Generally, the first parts 71a_1 and 71a_2 are parts connected to the lead wires 25 and 46 and inserted into the guide grooves 15_1 and 15_2, and the second parts 71b_1 and 71b_2 are parts which are withdrawn outward from the case 10′ so as to space the case 10′ at a certain interval apart from the circuit board. Also, the second parts 71b_1 and 71b_2 may each include one or more protruding portions 71c which improve heat dissipation performance.

In detail, the body 71_1 of the first pin 70_1 includes the first part 71a_1 having one side connected to the first thermistor lead wire 25 and inserted into the first guide groove 15_1 and the second part 71b_1 extending from the other side of the first part 71a_1 with a width greater than that of the first part 71a_1 and withdrawn outward from the case 10′. The body 71_2 of the second pin 70_2 includes the first part 71a_2 having one side connected to the fourth thermistor lead wire 46 and inserted into the second guide groove 15_2 and the second part 71b_2 extending from the other side of the first part 71a_2 with a width greater than that of the first part 71a_2 and withdrawn outward from the case 10′.

Meanwhile, since the negative temperature coefficient thermistors 20 and 40 and the fuse 30 are disposed to be adjacent to one another in a sealed space in the case 10′ such that a temperature of the circuit protection device or an ambient temperature thereof increases, there is concern that the fuse 30 is short-circuited by heat generation of the negative temperature coefficient thermistors 20 and 40 even when it is necessary to prevent the fuse 30 from being short-circuited. Accordingly, a partition wall 16′ may be installed among the fuse body 31 and the resistant heating elements 21 and 41 of the negative temperature coefficient thermistors 20 and 40 so as to maintain a certain interval or more among the fuse body 31 and the resistant heating elements 21 and 41. The partition wall 16′ may extend from an inner wall of the case 10′, for example, the rear wall 13. The partition wall 16′ is installed not to completely separate spaces in which the resistant heating elements 21 and 41 are accommodated from a space in which the fuse body 31 is accommodated so as to form paths through which the second thermistor lead wire 26 and the first fuse lead wire 32 extend and form paths through which the second fuse lead wire 33 and the third thermistor lead wire 45 extend. In one embodiment, the partition wall 16′ may include a first partition wall 16a extending from the rear wall 13 and a second partition wall 16b extending from an end of the first partition wall 16a both ways and having a width approximately corresponding to a length of the fuse body 31.

Referring to FIG. 13, the case 10′ is filled with the filler 80 while accommodating the negative temperature coefficient thermistors 20 and 40, the thermal fuse 30, and the like. The filler 80 not only supports the negative temperature coefficient thermistors 20 and 40 and the fuse 30 inside the accommodation grooves but also enables heat to be effectively dissipated from the negative temperature coefficient thermistors 20 and 40 and the fuse 30.

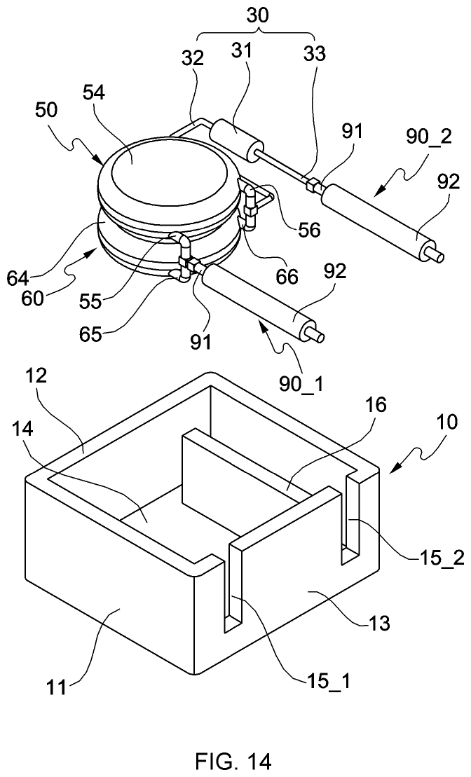

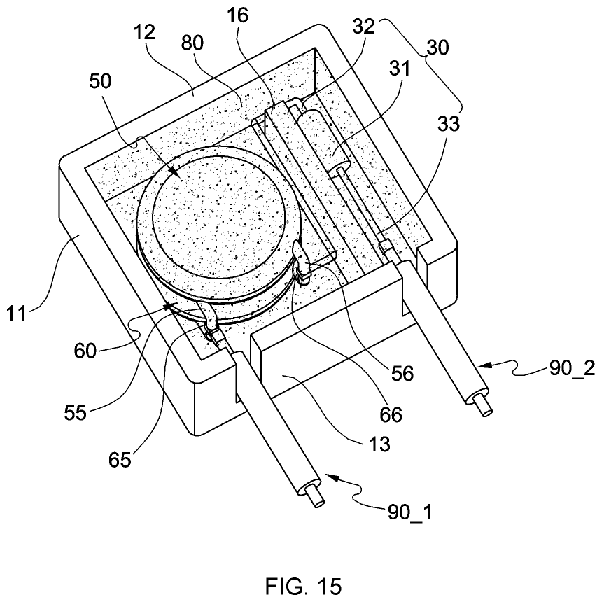

FIGS. 14 to 15 are views illustrating components of a circuit protection device according to a fourth embodiment of the present invention. FIG. 14 is a perspective view of the circuit protection device according to the fourth embodiment. FIG. 15 is a perspective view illustrating a state in which the case 10 accommodates the negative temperature coefficient thermistors 50 and 60, the fuse 30, and the like which are shown in FIG. 14 and then is filled with a filler.

In the fourth embodiment, in comparison to the second embodiment, the first pin 70_1 and the second pin 70_2 are replaced with a first cable 90_1 and a second cable 90_2, respectively. That is, in the embodiment, the circuit protection device is implemented not to be installed on the circuit board directly but to be installed separately from the circuit board and to be connected to a corresponding terminal of the circuit board using the first cable 90_1 and the second cable 90_2. For convenience, in the fourth embodiment, a redundant description overlapped with the second embodiment will be omitted.

The first cable 90_1 and the second cable 90_2 each include a conducting wire 91 and a sheath 92 surrounding the conducting wire 91. The first cable 90_1 and the second cable 90_2 may be harness cables.

In the first cable 90_1, the conducting wire 91 includes one end connected to the first thermistor lead wire 55 of the first negative temperature coefficient thermistor 50 and the third thermistor lead wire 65 of the second negative temperature coefficient thermistor 60 in the case 10 and extends through the first guide groove 15_1 such that the other end thereof is withdrawn outward from the case 10. In the second cable 90_2, the conducting wire 91 includes one end connected to the second fuse lead wire 33 of the fuse 30 in the case 10 and extends through the second guide groove 15_2 such that the other end thereof is withdrawn outward from the case 10.

Since the circuit protection device according to the fourth embodiment is installed separately from the circuit board, there is an advantage in which heat generated at the circuit protection device is not transferred to the circuit board at all.

In the fourth embodiment, although it has been described that the first pin 70_1 and the second pin 70_2 of the second embodiment are replaced with the first cable 90_1 and the second cable 90_2, respectively, the first pin 70_1 and the second pin 70_2 of the first embodiment and the third embodiment may also be replaced with the first cable 90_1 and the second cable 90_2, respectively.

A circuit protection device according to the present invention can replace a circuit protection device including a fuse resistor RF, a first relay S1, and a second relay S2. Since the circuit protection device includes a negative temperature coefficient thermistor and a fuse which are low-priced, costs may be reduced. The negative temperature coefficient thermistor and the fuse have a small volume and less occupy a space in comparison to relays. Also, since the relays are not used, it is possible to fundamentally remove a risk of an overcurrent or fire caused by a malfunction of the relays.

The exemplary embodiments of the present invention have been described above. It should be understood by one of ordinary skill in the art that the present invention may be implemented as a modified form without departing from the essential features of the present invention. Therefore, the disclosed embodiments should be considered not in a limitative view but a descriptive view. The scope of the present invention will be shown in the claims not in the above description, and all differences within an equivalent range thereof should be construed as being included in the present invention.

What is claimed is:

1. A circuit protection device comprising:
a case;
a negative temperature coefficient thermistor accommodated in the case and comprising a resistant heating element, a pair of electrodes installed on both sides of the resistant heating element, and a first thermistor lead wire and a second thermistor lead wire withdrawn from the pair of electrodes, respectively; and
a fuse accommodated in the case and comprising a fuse body and a first fuse lead wire and a second fuse lead wire connected to both ends of the fuse body, respectively,
wherein the fuse body comprises a fuse rod with a plating layer formed thereon and a pair of fuse caps coupled to both ends of the fuse rod and having conductivity, and the first fuse lead wire and the second fuse lead wire are bonded to the pair of fuse caps, respectively, and
wherein the second thermistor lead wire and the first fuse lead wire are connected to each other in the case.

2. The circuit protection device of claim 1, further comprising:
a first pin connected to the first thermistor lead wire; and
a second pin connected to the second fuse lead wire,
wherein a first guide groove configured to guide the first pin to be withdrawn outward from the case and a second guide groove configured to guide the second pin to be withdrawn outward from the case are formed in the case.

3. The circuit protection device of claim 2, wherein the first pin and the second pin comprise plate-shaped bodies having one sides connected to the first thermistor lead wire and the second fuse lead wire, respectively, and each comprise at least one extending portion extending from the other side of the body with a width smaller than that of the body.

4. The circuit protection device of claim 3, wherein the bodies of the first pin and the second pin comprise first parts having one sides connected to the first thermistor lead wire and the second fuse lead wire and inserted into the first guide groove and the second guide groove, respectively, and comprise second parts extending from other sides of the first parts with a width greater than that of the first parts and withdrawn outward from the case.

5. The circuit protection device of claim 1, wherein the case comprises a partition wall extending from an inner wall of the case and disposed between the resistant heating element and the fuse body.

6. A circuit protection device comprising:
a case;
a first negative temperature coefficient thermistor accommodated in the case and comprising a first resistant heating element, a pair of electrodes installed on both sides of the first resistant heating element, and a first thermistor lead wire and a second thermistor lead wire withdrawn from the pair of electrodes, respectively;
a second negative temperature coefficient thermistor accommodated in the case and comprising a second resistant heating element, a pair of electrodes installed on both sides of the second resistant heating element, and a third thermistor lead wire and a fourth thermistor lead wire withdrawn from the pair of electrodes, respectively; and
a fuse accommodated in the case and comprising a fuse body and a first fuse lead wire and a second fuse lead wire connected to both ends of the fuse body, respectively,
wherein the fuse body comprises a fuse rod with a plating layer formed thereon and a pair of fuse caps coupled to both ends of the fuse rod and having conductivity, and the first fuse lead wire and the second fuse lead wire are bonded to the pair of fuse caps, respectively,
wherein the first thermistor lead wire and the third thermistor lead wire are connected to each other in the case, and
wherein the second thermistor lead wire, the fourth thermistor lead wire, and the first fuse lead wire are connected to one another in the case.

7. The circuit protection device of claim 6, further comprising:
a first pin connected to the first thermistor lead wire and the third thermistor lead wire; and
a second pin connected to the second fuse lead wire,
wherein a first guide groove configured to guide the first pin to be withdrawn outward from the case and a second guide groove configured to guide the second pin to be withdrawn outward from the case are formed in the case.

8. The circuit protection device of claim 7, wherein the first pin comprises a plate-shaped body having one side connected to the first thermistor lead wire and the third thermistor lead wire and comprises at least one extending portion extending from the other side of the body with a width smaller than that of the body.

9. The circuit protection device of claim 8, wherein the body comprises a first part having one side connected to the first thermistor lead wire and the third thermistor lead wire and inserted into the first guide groove and comprises a second part extending from the other side of the first part with a width greater than that of the first part to be located outside the case.

10. The circuit protection device of claim 7, wherein the second pin comprises a plate-shaped body having one side connected to the second fuse lead wire and comprises at least one extending portion extending from the other side of the body with a width smaller than that of the body.

11. The circuit protection device of claim 10, wherein the body comprises a first part having one side connected to the second fuse lead wire and inserted into the second guide groove and comprises a second part extending from the other side of the first part with a width greater than that of the first part to be located outside the case.

12. The circuit protection device of claim 6, wherein the case comprises a partition wall extending from an inner wall of the case and disposed among the first resistant heating element, the second resistant heating element, and the fuse body.

13. The circuit protection device of claim 6, wherein the first resistant heating element and the second resistant heating element are disposed to face each other.

14. The circuit protection device of claim 6, further comprising:
a first cable having one end connected to the first thermistor lead wire and the third thermistor lead wire; and
a second cable having one end connected to the second fuse lead wire,
wherein a first guide groove configured to guide the first cable to be withdrawn outward from the case and a second guide groove configured to guide the second cable to be withdrawn outward from the case are formed in the case.

15. A circuit protection device comprising:
a case;
a first negative temperature coefficient thermistor accommodated in the case and comprising a first resistant heating element, a pair of electrodes installed on both sides of the first resistant heating element, and a first thermistor lead wire and a second thermistor lead wire withdrawn from the pair of electrodes, respectively;
a fuse accommodated in the case and comprising a fuse body and a first fuse lead wire and a second fuse lead wire connected to both ends of the fuse body, respectively; and
a second negative temperature coefficient thermistor accommodated in the case and comprising a second resistant heating element, a pair of electrodes installed on both sides of the second resistant heating element, and a third thermistor lead wire and a fourth thermistor lead wire withdrawn from the pair of electrodes, respectively,
wherein the fuse body comprises a fuse rod with a plating layer formed thereon and a pair of fuse caps coupled to both ends of the fuse rod and having conductivity, and the first fuse lead wire and the second fuse lead wire are bonded to the pair of fuse caps, respectively, and
wherein the second thermistor lead wire and the first fuse lead wire are connected to each other, and the second fuse lead wire and the third thermistor lead wire are connected to each other in the case.

16. The circuit protection device of claim 15, further comprising:
a first pin connected to the first thermistor lead wire; and
a second pin connected to the fourth thermistor lead wire,
wherein a first guide groove configured to guide the first pin to be withdrawn outward from the case and a second guide groove configured to guide the second pin to be withdrawn outward from the case are formed in the case.

17. The circuit protection device of claim 16, wherein the first pin and the second pin comprise plate-shaped bodies having one sides connected to the first thermistor lead wire and the fourth thermistor lead wire, respectively, and each comprise at least one extending portion extending from the other side of the body with a width smaller than that of the body.

18. The circuit protection device of claim 17, wherein the bodies of the first pin and the second pin comprise first parts having one sides connected to the first thermistor lead wire and the fourth thermistor lead wire and inserted into the first guide groove and the second guide groove, respectively, and comprise second parts extending from other sides of the first parts with a width greater than that of the first parts and withdrawn outward from the case.

19. The circuit protection device of claim 15, wherein the case comprises a partition wall extending from an inner wall of the case and disposed among the first resistant heating element, the second resistant heating element, and the fuse body.
